(19) United States
(12) Patent Application Publication
(10) Pub. No.: US 2001/0032365 A1
(43) Pub. Date: Oct. 25, 2001

(54) Knee and ankle alignment pillow

(76) Inventor: Roger Sramek, Sausalito, CA (US)

Correspondence Address: LAW OFFICES OF JONATHAN ALAN QUINE, P O BOX 458, ALAMEDA, CA, 94501

(21) Appl. No.: 09/800,456

(22) Filed: Mar. 2, 2001

Related U.S. Application Data
(60) Provisional application No. 60/186,944, filed on Mar. 4, 2000.

(51) Int. Cl. A47C 17/86; B68G 5/00; A47C 20/02

(52) U.S. Cl. 5/652

(57) ABSTRACT

Pillows which are designed to fit the legs of a user during sleep or recovery from surgery are provided.

### CROSS-REFERENCE TO RELATED APPLICATIONS

This application is a non-provisional application related to U.S. Ser. No. 60/186,944, “Knee and Ankle Alignment Pillow” filed Mar. 4, 2000. The present application claims priority to and benefit of U.S. Ser. No. 60/186,944, which is incorporated herein by reference for all purposes.

### FIELD OF THE INVENTION

The present invention relates to pillows, particularly pillows which are designed to accommodate the legs of a person during rest.

### BACKGROUND OF THE INVENTION

Recently there has been renewed interest in the design of specialized pillows for improved comfort and to provide medical benefits. For example, U.S. Pat. No. 6,006,380 “Adjustable cervical pillow with depressions for a user's ear;” U.S. Pat. No. D416,742 “Adjustable pillow;” U.S. Pat. No. 5,926,880 “Adjustable cervical pillow with depressions for a user's ears;” and U.S. Pat. No. 5,781,947 “Adjustable cervical pillow with depressions for a user's ears;” all by Sramek, provide fundamental advances in head and neck pillow designs, providing pillows that improve comfort, reduce snoring and which can reduce incidence of sleep apnea.

In addition to pillows which serve to cushion the head of a user, pillows are often used to cushion other parts of a user's anatomy during rest or sleep. For example, standard bed pillows are often used under the knees or between the legs of a user to provide general comfort while sleeping. This can lead to improper spinal alignment, undue pressure on the knees and ankles or other unwanted effects.

Specialized pillows for aligning the lower back which are designed to fit under and between a user's legs have been proposed (e.g., Stokes, U.S. Pat. No. 5,878,453), but these pillows are relatively complicated, involving several pieces and, in some cases, extending well above the body of a user, e.g., while lying supine. This makes it awkward to use the pillow when bedcovers are in place.

Similarly, several pillows which are designed to fit between or under a user's legs are commercially available, including: the “knee pillow” from Burbank Valley Products (www.burbankvalley.com/knee.htlm); the “Angel Foam™ knee pillow” (www.janlee.com/kneepillow.htm); the “Contour Cloud™” (www.feelgoodfast.com); the Ortho Support Buddy™ pillow, the Ortho Support Ortho Adjustable Knee Cushion™ pillow, and the Bed Wedge Leg Support™ Cushion, all now or formerly available from Self Care (www.selfcare.com or www.gaiam.com); and the Contour Leg Pillow (www.comfort-trac.com). However, these pillows generally lack multipurpose functionality, i.e., the pillows are not generally well-suited to alternate uses for different sleeping positions (e.g., between the legs of a person when side-sleeping and under the legs of a user when sleeping prone or supine). Moreover, certain of these pillows can actually pull the spine out of proper alignment during use.

Finally, specialized pillows which address post-surgical recovery uses in the cases of back, hip, knee, ankle or foot surgery are generally lacking.

The present invention provides simple and effective knee/ankle alignment pillows which remedy the above noted deficiencies in the prior art, providing comfort for the general user during rest such as nightly sleep. The pillows of the invention can also help speed recovery following back, knee, hip, ankle or foot surgery and may provide pain relief to arthritis sufferers. Further details regarding the structure function and manufacture of the pillows of the invention will be apparent upon review of the following.

### SUMMARY OF THE INVENTION

The present invention provides pillows which fit and/or elevate the legs of a user during use of the pillow, in supine, side sleeping and prone positions. The pillow comprises a resilient body structure comprising a first groove extending longitudinally through an inward or central region of a first side of the body and a second groove opposed to the first groove on a second side of the body. The first and second grooves are each contoured to receive a leg of a person, e.g., when the pillow is fitted between the legs of the user.

Typically, the resilient body structure has an upper face, which includes a first sloping region and a second sloping region. The first and second sloping regions are at least partly separated on the upper face by an upper face groove extending longitudinally along an at least partly inward region of the upper face, e.g., where the first and second sloping regions are each at least partially outwardly sloped from an outer region of the upper face towards the inward region of the upper face.

The resilient body also typically includes a bottom face opposite the upper face. Most typically, the top and bottom faces of the body are symmetrical. Thus, the bottom face typically has a third sloping region and a fourth sloping region, which are separated on the bottom face by a bottom face groove extending longitudinally along an at least partly inward region of the bottom face. The bottom face grove is typically opposed to the upper face groove on opposite sides of the resilient body structure, where the third and fourth sloping regions are each at least partly outwardly sloped from an outer region of the bottom face towards the inward region of the bottom face. The upper face and bottom face grooves are each contoured to receive a leg of a user, e.g., when side sleeping.

A typical configuration of the pillow body is a double-lobed or double-wedged structure with the lobes or wedges (which can include flat or curved surfaces) being joined at edges of the grooves. Thus, in one embodiment, the body has a first resilient lobe or wedge structure that extends from a first edge of the upper face groove to a first edge of the bottom face groove. In this embodiment, the lobe or wedge includes the first and third sloping regions. Similarly, a second resilient lobe or wedge structure that extends from a second edge of the upper face groove to a second edge of the bottom face groove can be included, e.g., in which the lobe or wedge includes the second and fourth sloping regions. The lobes or wedges can be adjustable.

Thus, in one embodiment, the first and third sloping regions form a first wedge or lobe while the second and fourth sloping regions form a second wedge or lobe. The first and second wedges or lobes are formed in opposite orientations, with opposing grooves connecting the opposing wedges/lobes. Advantageously, the slopes and dimensions of the first, second, third and fourth sloping regions are selected to provide support to the legs of a user when sleeping in a supine or prone position.

A variety of basic configurations of the sloping regions can be adopted. For example, the slope of the first and second sloping regions are most typically equal, but can also be different. Similarly, the slope of the third and fourth sloping regions are typically equal, but can differ. In one typical embodiment, the pillow is symmetrical, and, thus, the slope of the first, second, third and fourth sloping regions are equal. However, one or more portions of the pillow body is/are optionally non-symmetrical.

While the pillow body is typically formed from a single piece of resilient material, it can also be formed from multiple pieces of one or more resilient materials. The body can also incorporate features for customizing the pillow to an individual user, or which modify the function of the basic pillow design. For example, the body optionally includes a tear away portion, an inflatable portion, a re-attachment portion, or an adjustable portion. For example, to properly size the pillow for a user, the pillow can be formed of abutting tear away sections that provide for easy overall size (e.g., length) adjustment of the pillow. Similarly, inflatable portions can be used to modify the dimensions of the pillow to fit a particular user. Other adjustable portions (e.g., adhesive (e.g., hook and loop (e.g., Velcro™) fasteners can be used to provide for the addition to or removal from components of the basic pillow design.

Methods of manufacturing the pillows, e.g., by providing the elements of the pillows in operable combination, are provided. Typically, the body structure is fabricated by injection molding, e.g., of a urethane foam, or by die (or “contour”) cutting a urethane blank. The pillow can also be provided in customizable form, providing for use of tear-away sections or inflatable portions to provide the final pillow body configuration.

The body can be made from any material typically used in pillow construction, including, e.g., plastic foam, urethane foam, feathers, natural fibers, etc. Most typically, the pillows of the invention are made from one or more urethane foam(s), although other resilient man made and natural materials are also appropriate. Commonly, the urethane or other foam is shaped into pillow components using a cavity molding or free-rise molding process, or by cutting (e.g., die cutting) a foam blank to a desired size and shape. Most commonly, foams used for the pillow components of the invention will be standard polyurethane foams, though more advanced “memory” foams such as TEMPER FOAM®, MEMORY FOAM®, MEMORY FLEX® and VISCO ELASTIC® can also be used for all or a portion of the pillow body.

Uses of the pillows and of the manufacturing methods herein are provided. Kits comprising the elements of the pillows in conjunction with, e.g., packaging materials and assembly instructions are provided.

### BRIEF DESCRIPTION OF THE DRAWING

FIG. 1, panels A-G are schematic drawings of a pillow of the invention, along with a user showing use of the pillow in supine, side sleeping and prone positions.

### DESCRIPTION OF THE PREFERRED EMBODIMENT

The knee-ankle pillows of the invention are designed to fit the legs of a user, particularly between and including the knees and ankles of the user. The pillows provide enhanced knee, ankle and leg comfort, as well as improved spinal alignment, when compared to placing a standard pillow between the legs of the user. The pillows are designed to provide support between the legs (e.g., when side sleeping), or under the legs (e.g., when the user is in a prone or supine position).

While the majority of users are accommodated with a single unit pillow body, or simply by varying the sizes of such a body (e.g., providing small, medium, large and extra large pillows), the pillows are optionally individually customizable and can include multiple components. For example, the pillows can be individually configured for optimal comfort, optionally including features such as tear-away portions, inflatable portions, adhesive portions, attachable portions (e.g., hook and loop (VELCRO™) systems), or the like.

Typically, the materials used in the pillow bodies are of a suitable density and compressibility to support one or both of a person's legs. The pillows of the invention are optionally made from one or more of a variety of resilient materials, such as man-made plastic foams (e.g., polyurethanes), feathers (e.g., goose or duck down) or natural fibers (e.g., cotton, kapok, or the like). Preferably, the pillows of the invention are made from any of a variety of resilient urethane foams, e.g., by molding polyurethane in a cast, or, even more commonly, by contour (die)-cutting the polyurethane from a larger resilient polyurethane foam blank.

“Resilient” pillow component materials are those which compress or flex with the application of pressure (e.g., the weight of a person's leg or body applied to the component during use). Resilient components tend to return to approximately the same shape when the pressure is removed from the component.

Materials with shape memory, i.e., which retain the shape of a pressure imprint for a time, slowly returning to approximately the shape of the component prior to the application of pressure, are considered “resilient” materials for purposes of this disclosure. Examples of such materials include polyurethane isocyanate foam components which conform to a person's legs at body temperature and/or under body weight pressure, but which gradually return to an original shape after the person's legs are removed from the component and/or the component cools to room temperature (certain forms of such foams soften with temperature, while others do not). Similarly, down or natural fiber pillow components which are quilted or packed to retain a given shape are “resilient” materials for purposes of this disclosure.

It is expected that one of skill is fully aware of manufacturing methods for making and shaping resilient polyurethane foams. A general introduction to the manufacture of plastics in general, and urethane foams in particular is found in Kirk-Othmer Encyclopedia of Chemical Technology third and fourth editions, esp. volumes 18 and volume 23, Martin Grayson, Executive Editor, Wiley-Interscience, John Wiley and Sons, NY, and in the references cited therein (“Kirk-Othmer”).

Resilient flexible urethane foams are typically processed into pillow components, or blanks from which these components are cut using known techniques such as “die” or “contour” cutting. These techniques can include, e.g., free rise processing, extrusion, cavity molding, injection molding, structural foam molding, rotational molding, thermoforming, calendaring, thermosetting, reaction injection molding, and the like. See, Kirk-Othmer, supra.

The physical properties of urethane foams such as indentation force deflection (° F.)), modulus (i.e., Young's modulus; stress=force/area; the resulting relative change in size is termed strain and the modulus of elasticity=stress/strain) and rebound depend on, e.g., the density of the foam, the catalyst used to set the foam, the presence of surfactant in the foam, the presence of polyols and isocyanates and the type of mixing. A variety of manufacturing techniques are known for both thermoplastic and thermosetting urethanes, and polyurethanes and associated solvents, reagents, catalysts and the like are commercially available from J. P. Stevens (East Hampton, Mass.) as well as many other commercial sources such as Akzo, BASF, Dow, Mobay, Olin, Rubicon, Upjohn, Bayer, Takeda, Veba, Eastman, Sun Oil, and other manufacturers known to persons of skill. See also, Kirk Othmer, id.

For example, in the free rise process, the chemical components of the urethane foam are mixed, e.g., in a vat or in a slip-form mold where they foam and rise. Bales of the foam are cut into blanks and milling is performed using a cutting tool such as a “contour” or “die” cutter (or, even, optionally, by hand cutting the blank). The die or contour cutter performs a set cutting operation, by a combination of the shape of the cutting heads and the movement instructions provided to the cutting heads, to produce a pillow body having a given shape.

In the cavity molding process, a shaped cavity is made, e.g., from fiberglass or aluminum. The chemical components of the urethane foam are sprayed into the shaped cavity, where they expand to fit the shaped cavity. The cavity is then opened, and the shaped foam is released.

While the pillows of the invention are typically made from low-cost foams to reduce manufacturing costs, the foams used in the pillow can be made from a higher grade of foam such as a “memory” foam. One of skill can make such foams using known techniques, and several suitable classes of foams are commercially available, such as TEMPER FOAM® (available, e.g., from Kees Goebel Medical, Hamilton, Ohio), MEMORY FOAM®, MEMORY FLEX®, and VISCO ELASTIC® (all available, e.g., from North Carolina Foam, Inc., Mount Airy, N.C., as well as a variety of other commercial sources).

Optional inflatable portions of the pillows of the invention can include air or fluid bladders, e.g., comprising reinforcing regions for controlling expansion and the shapes of the bladders resulting from expansion. For example, nylon mesh or other synthetic materials can be incorporated into the bladders. The main portion of an air (or hydraulic) bladder is made from rubber, plastic, or any other air (or water or other fluid)-tight inflatable material.

In one embodiment, the pillows of the invention have an absorptive pillow covering encasing the pillow body. This absorptive covering can be made from a bacteriocidal fabric such as STAPH-CHECK®. The pillow, with or without an absorptive covering is often used in conjunction with a loose-fitting pillow case. In one embodiment, the pillow case is made from a silk, cotton, synthetic or blended fabric.

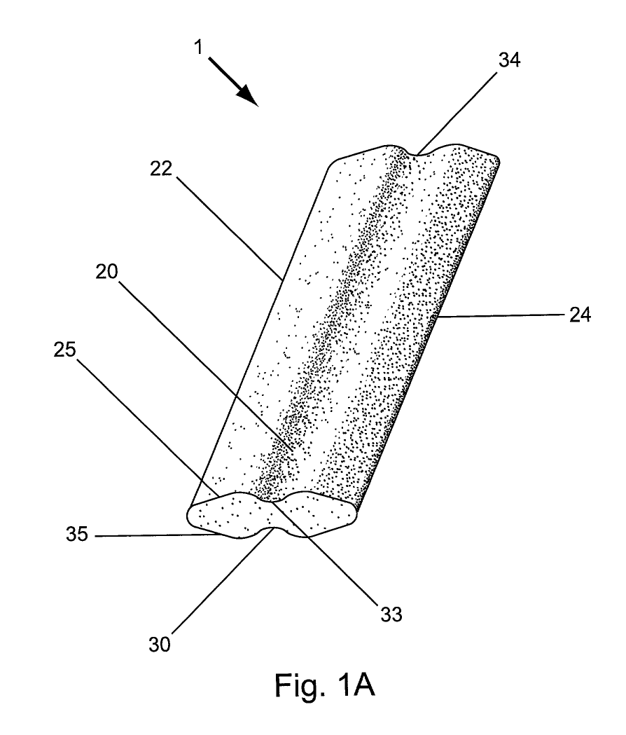

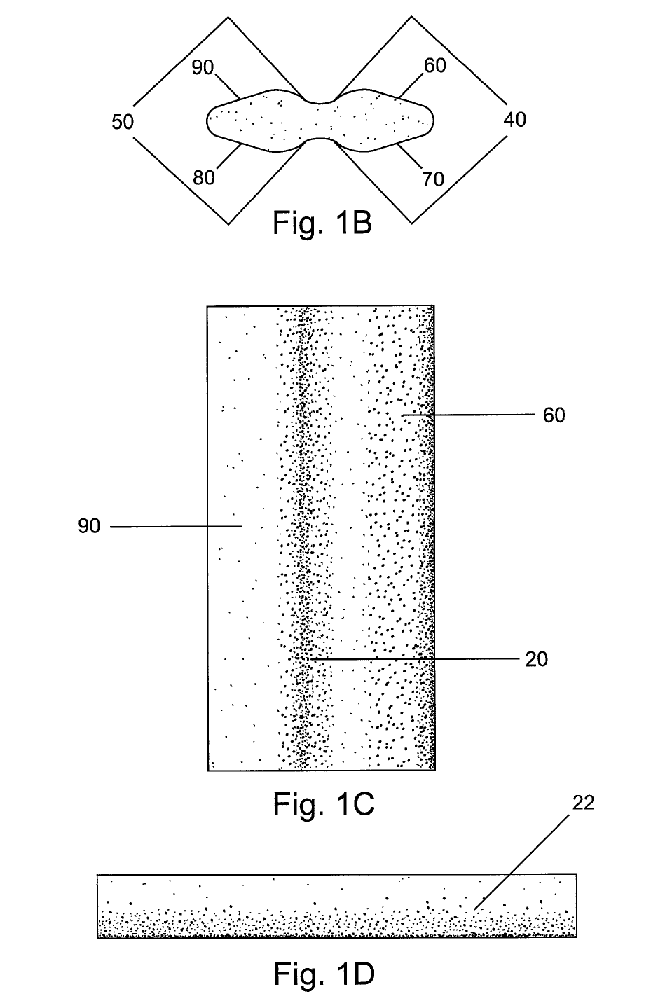

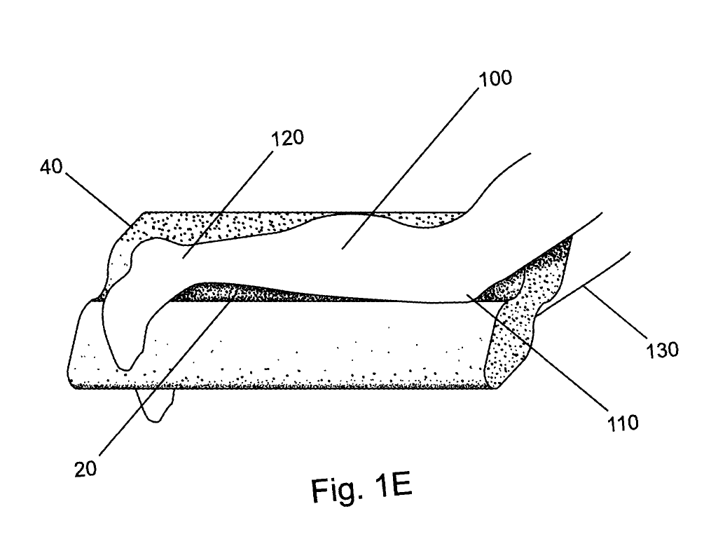

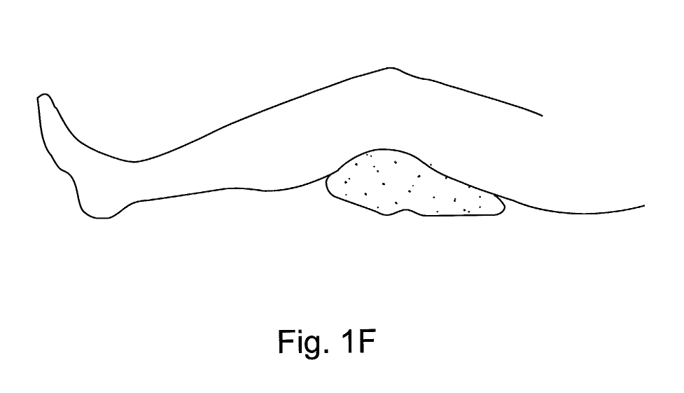

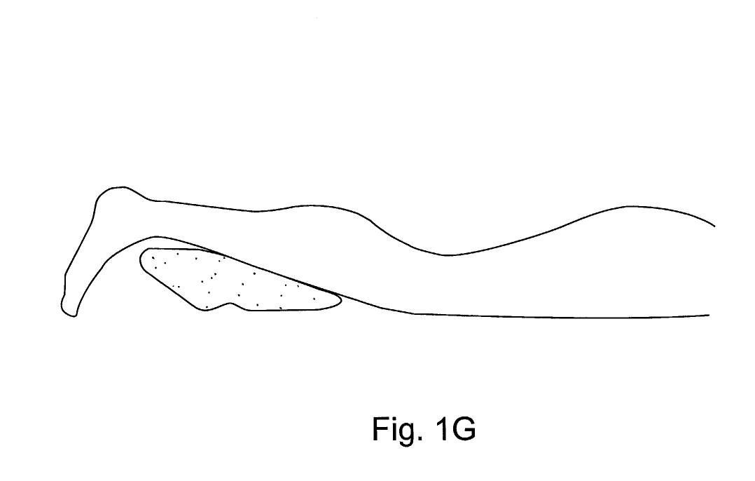

The invention is illustrated with reference to FIG. 1, panels A-G. As depicted, FIG. 1A provides a top perspective view of one embodiment of the pillow body. FIG. 1B provides a cross-sectional end view of the pillow body. FIG. 1C provides a top view of the pillow body. FIG. 1D provides a side view of the pillow body.

FIG. 1E provides a view of the pillow in use by a user who is resting on the user's side, e.g., in a side-sleeping position. This fixes the knees and ankles of the user in an aligned position, resulting in proper pelvic and spinal alignment. FIG. 1F provides a view of the pillow in use by a user sleeping or resting supine (face up), with the pillow supporting the upper legs of the user. This eliminates knee hyperextension and preserves correct lordosis (curvature) in the lower spine. FIG. 1G provides a view of the pillow in use by a user sleeping in a prone (face down) position, with the pillow supporting the lower legs of the user to reduce stress on the feet and ankles of the user when sleeping prone. This lifts the lower legs of the user preventing hyperextension of the knees and preserving correct lordosis of the lower spine.

As shown, pillow body 1 comprises upper face (central) groove 20 on upper pillow face 25. Groove 20 is formed along an inward portion of pillow face 25, i.e., a portion that extends between outer face regions 22 and 24. That is, while groove 20 extends to end edge 33 and end edge 34, the groove is inward from outer face regions 22 and 24. Thus, a pillow face or body region is “inward” if it is located between at least two outer regions (e.g., opposing regions) of the pillow face or body.

As depicted, pillow body 1 is symmetrical, comprising central groove 30 on bottom face 35, with the bottom face having the same features as the upper face. This symmetry is further illustrated in FIG. 1B.

It will be understood that the use of the terms “upper” and “bottom” with respect to the faces of the pillow are intended to facilitate discussion, rather than to limit the positioning of the pillow, or to necessarily indicate a particular orientation of the components. That is, the upper face may actually be the bottom of the pillow during use and vice-versa, depending on the position of the pillow during use. Of course the upper and bottom faces may actually be vertical faces as well, e.g., if the pillow is held in a vertical orientation.

Resilient curved wedge portions 40 and 50 are depicted, e.g., in FIG. 1B. As shown, the portions are formed in partly curved wedge shapes that include sloped regions 60, 70, 80, and 90. As shown, the sloped regions slope outward, that is, the thickest point of the wedges is towards the center of the pillow, with the outer edges being less thick. The wedges are partly curved in that outer regions 22 and 24 form a curve from the top to the bottom of the pillow body, rather than coming to a point. In other embodiments, the regions are still more curved, making the shapes more lobe-like than wedge like. The precise angle of the wedges or lobes (and, thus, the slopes of the sloped regions) varies depending on the application. For example, if greater lifting of the legs during supine or prone sleeping is desired, the angle (and/or thickness of the wedges) can be increased. The slopes of the sloped regions typically range from between about 5° and about 45° above horizontal. Resilient wedges 40 and 50 can have essentially flat sloped regions as depicted, or the sloped regions can be more rounded, resulting in a more lobed or bulbous appearance.

FIG. 1E shows the pillow in use by a user sleeping in a side-sleeping position. As shown, user's right leg 100 fits into groove 20, including the joints of user knee 110 and ankle 120. Right leg 100 is partly separated from left leg 130 (which fits into groove 30 on the bottom face of the pillow) by lobe/wedge 40. Thus, as shown, when lying in a side-sleeping position, grooves 20 and 30 receive the legs of the user, e.g., in the region from the knee (or slightly above the knee) to the ankle. As depicted, the pillow is about 20-30 (e.g., about 24) inches long; however, this length can easily be customized to a length of the leg of the user. The knee of the user can fit into grooves 20 and 30, or a widened portion of the groove at one end of the pillow body can be provided to permit partial rotation of the knee. Of course, a slightly widened region can also be provided at the other end of the pillow to provide for partial rotation of the ankle.

FIG. 1F depicts a user resting supine with the weight of the user's legs partly compressing the pillow (e.g., lobe 40). As depicted, the user's legs are held in a more comfortable position that avoids knee hyper-extension and which preserves correct lordosis in the lower spine. As shown, when lying supine, lobe portion 40 is compressed relative to lobe 50, thereby preserving lordosis in the lower spine and providing comfortable support to the legs of the user. Compression of the pillow by the user's legs is slightly exaggerated for purposes of illustration.

Similarly, FIG. 1G further shows compression of wedge 40 when the user is lying prone, again preventing stress on the feet and hyperextension of the knees while preserving correct lordosis of the spine. Again, compression of the pillow by the user's legs is slightly exaggerated for purposes of illustration.

As depicted, the wedge portions are typically about 3-5 inches thick at the thickest point, but this thickness can be customized to the size of the user, either by providing different molds or different cutting instructions to produce pillows with different heights, or, e.g., by providing tear-away foam pieces (e.g., which optionally include perforations) which can be removed or attached (e.g., using VELCRO™) to the main pillow body to adjust the overall size or shape of the pillow body. Similarly, the lobe/ wedge regions (or the grooves) can include inflatable bladders to customize any portion of the pillow to the user.

The foregoing description of the device of the invention is illustrative and not limiting. All publications, patents, patent applications and other documents cited herein are incorporated by reference for all purposes to the extent as if each were specifically and individually indicated to be incorporated by reference for all purposes.

What is claimed is:

1. A knee and ankle alignment pillow, comprising a resilient body structure, the body structure comprising:
an upper face, which upper face comprises a first sloping region and a second sloping region, which first and second sloping regions are at least partly separated on the upper face by an upper face groove extending longitudinally along an at least partly inward region of the upper face, wherein the first and second sloping regions are each at least partially outwardly sloped from an outer region of the upper face towards the inward region of the upper face; and,
a bottom face opposite the upper face, which bottom face comprises a third sloping region and a fourth sloping region, which third and fourth sloping regions are separated on the bottom face by a bottom face groove extending longitudinally along an at least partly inward region of the bottom face, which bottom face grove is opposed to the upper face groove on opposite sides of the resilient body structure, wherein the third and fourth sloping regions are each at least partly outwardly sloped from an outer region of the bottom face towards the inward region of the bottom face;
wherein the upper face and bottom face grooves are each contoured to receive a leg of a user.

2. The pillow of claim 1, comprising a first resilient lobe structure that extends from a first edge of the upper face groove to a first edge of the bottom face groove, which lobe comprises the first and third sloping regions.

3. The pillow of claim 2, wherein the first resilient lobe is adjustable.

4. The pillow of claim 2, comprising a second resilient lobe structure that extends from a second edge of the upper face groove to a second edge of the bottom face groove, which lobe comprises the second and fourth sloping regions.

5. The pillow of claim 4, wherein the second resilient lobe is adjustable.

6. The pillow of claim 1, wherein one or more of the body structure, the upper face groove or the lower face groove is adjustable.

7. The pillow of claim 1, wherein the slope of the first and second sloping regions are equal.

8. The pillow of claim 1, wherein the slope of the third and fourth sloping regions are equal.

9. The pillow of claim 1, wherein the slope of the first, second, third and fourth sloping regions are equal.

10. The pillow of claim 1, wherein the slope of the first, second, third and fourth sloping regions are selected to provide support to the legs of a user when sleeping in a suppine or prone position.

11. The pillow of claim 1, wherein the body comprises one or more of: plastic foam, urethane foam, feathers, or natural fiber.

12. The pillow of claim 1, wherein the body comprises one or more of: a tear away portion, an inflatable portion, or an adjustable portion.

13. The pillow of claim 1, wherein the body is formed from a single piece of resilient material.

14. The pillow of claim 1, wherein the body is formed from multiple pieces of one or more resilient material.

15. A method of making a pillow, comprising forming a body structure comprising an upper face, which upper face comprises a first sloping region and a second sloping region, which first and second sloping regions are at least partly separated on the upper face by an upper face groove extending longitudinally along an at least partly inward region of the upper face, wherein the first and second sloping regions are each at least partially outwardly sloped from an outer region of the upper face towards the inward region of the upper face; and,
a bottom face opposite the upper face, which bottom face comprises a third sloping region and a fourth sloping region, which third and fourth sloping regions are separated on the bottom face by a bottom face groove extending longitudinally along an at least partly inward region of the bottom face, which bottom face grove is opposed to the upper face groove on opposite sides of the resilient body structure, wherein the third and fourth sloping regions are each at least partly outwardly sloped from an outer region of the bottom face towards the inward region of the bottom face;
wherein the upper face and bottom face grooves are each contoured to receive a leg of a user.

16. The method of claim 15, wherein the forming step comprises injecting a urethane foam into a mold.

17. The method of claim 15, wherein the forming comprises die cutting a foam blank.

18. The method of claim 15, wherein the forming step comprises providing tear away strips of foam on the first or second side of the pillow.

19. The method of claim 15, comprising providing an inflatable portion within the body structure.

20. The method of claim 19, comprising inflating the inflatable portion.
